(19) United States
(12) Patent Application Publication
(10) Pub. No.: US 2018/0052824 A1
(43) Pub. Date: Feb. 22, 2018

(54) TASK IDENTIFICATION AND COMPLETION BASED ON NATURAL LANGUAGE QUERY

(71) Applicant: Microsoft Technology Licensing, LLC, Redmond, WA (US)

(72) Inventors: Reza Ferrydiansyah, Redmond, WA (US); Diego Carlomagno, Redmond, WA (US); Joseph Spencer King, Seattle, WA (US); Farhaz Karmali, Kirkland, WA (US); Chidambaram Muthu, Bothell, WA (US); RaghuRam Nadiminti, Redmond, WA (US); Talon Edward Ireland, Kirkland, WA (US); Alexis Hernandez, Redmond, WA (US); Travis Robert Wilson, Redmond, WA (US)

(21) Appl. No.: 15/356,523

(22) Filed: Nov. 18, 2016

Related U.S. Application Data
(60) Provisional application No. 62/377,503, filed on Aug. 19, 2016.

(51) Int. Cl. G06F 17/27; H04L 29/08; G06F 17/30; G06N 99/00

(52) U.S. Cl. CPC G06F 17/2785; G06F 17/2705; G06N 99/005; G06F 17/30401; G06F 17/30867; H04L 67/306

(57) ABSTRACT

Examples of the disclosure provide a system and method for task completion using a digital assistant. Natural language data input is received and user intent associated with the natural language data input is identified. A structured query is generated for the natural language data input based on the identified user intent. A response to the structured query is received from a search engine and a determination is made as to whether the response includes one or more results. A result is selected for task completion based at least in part on user context, in response to a determination that the response includes one or more results.

### CROSS-REFERENCE TO RELATED APPLICATION

This application claims the benefit of U.S. Provisional Patent Application Ser. No. 62/377,503, entitled “Task Identification and Completion Based on Natural Language Query” and filed on Aug. 19, 2016, which is incorporated herein by reference in its entirety for all intents and purposes.

### BACKGROUND

Intelligent agent systems may respond to questions or commands using information from a variety of databases or models. Some intelligent agent systems may also access stored user profile information to draw upon when generating responses or performing an action.

### SUMMARY

Examples of the disclosure provide a system and method for task completion using a digital assistant. Natural language data input is received and user intent associated with the natural language data input is identified. A structured query is generated for the natural language data input based on the identified user intent. A response to the structured query is received from a search engine and a determination is made as to whether the response includes one or more results. A result is selected for task completion based at least in part on user context, in response to a determination that the response includes one or more results.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for identifying and completing tasks based on natural language input using a digital assistant.

FIG. 2 is an exemplary block diagram illustrating a digital assistant for identifying and completing a task using natural language input.

FIG. 3 is an exemplary flow chart illustrating operation of the computing device to identify and complete a task using natural language input.

FIG. 4 is an exemplary flow chart illustrating operation of the computing device to confirm an identified and selected task with a user for task completion.

FIG. 5 is an exemplary diagram illustrating a mobile device implementing the digital assistant.

FIG. 6 is an exemplary block diagram illustrating an operating environment for a computing device implementing a digital assistant.

Corresponding reference characters indicate corresponding parts throughout the drawings.

### DETAILED DESCRIPTION

Referring to the figures, examples of the disclosure enable an intelligent agent or digital assistant to identify and complete a task using natural language data input. The digital assistant identifies the intent associated with the natural language, which may be ambiguous, and a domain corresponding to the natural language and the identified intent, using the intent and domain to generates a structured, or unambiguous, query. This creates structure for a query search based on the natural language input. Using search engine ranking associated with returned results to the structured query, the digital assistant identifies a result for selection, which may be based on the specified domain, contextual analysis for a user associated with the natural language data input, user confirmation in response to a digital assistant-generated query, or other parameters, such as market data, user history, user preference, cloud-sourced data, and the like. The task is completed using the selected result based on the data source or data provider that the system identifies as available and/or preferred.

Aspects of the disclosure further provide increased user interaction performance by providing dynamic task identification and completion in response to ambiguous natural language input, enabling a user to provide contextual queries rather than exact queries to achieve task completion. The resulting efficiency improvements in user interactions saves the user time by reducing or eliminating the need for the user to manually complete a task, and the need for the user to learn or remember keywords or query formats in order to achieve the desired task using natural language agents.

The information environment currently provided is vast, resulting in users being overloaded with information. Often, intelligent agents are used to manage, organize, or retrieve information. Generally, intelligent agents do not have the contextual capability to understand queries that are not exact when it comes to finding specific information or performing a specific task. Most natural language agents require appropriate keywords in order to understand what is being asked and how to complete the request. For example, an intelligent agent, or natural language agent, may require an exact title of a song be input in order to locate and retrieve the desired musical file.

Examples of this disclosure provide a system and method for simplifying user access to desired information by allowing the user to formulate an information request using natural language, reducing or eliminating the need to for the information request to be structured, specific, or complete, and using contextual analysis to understand the request, determine intent and domain, and generate a structured request that achieves the desired task or returns the desired information corresponding to the natural language information request. The examples provided herein allows a user the ability to search for content without knowing specific identifiers of the content, such as file name or author, such as requesting to play specific music without actually knowing the name of the song. Aspects of the disclosure infer the relevant identifying information, such as a track name of a song on an album, using machine learning and contextual analysis.

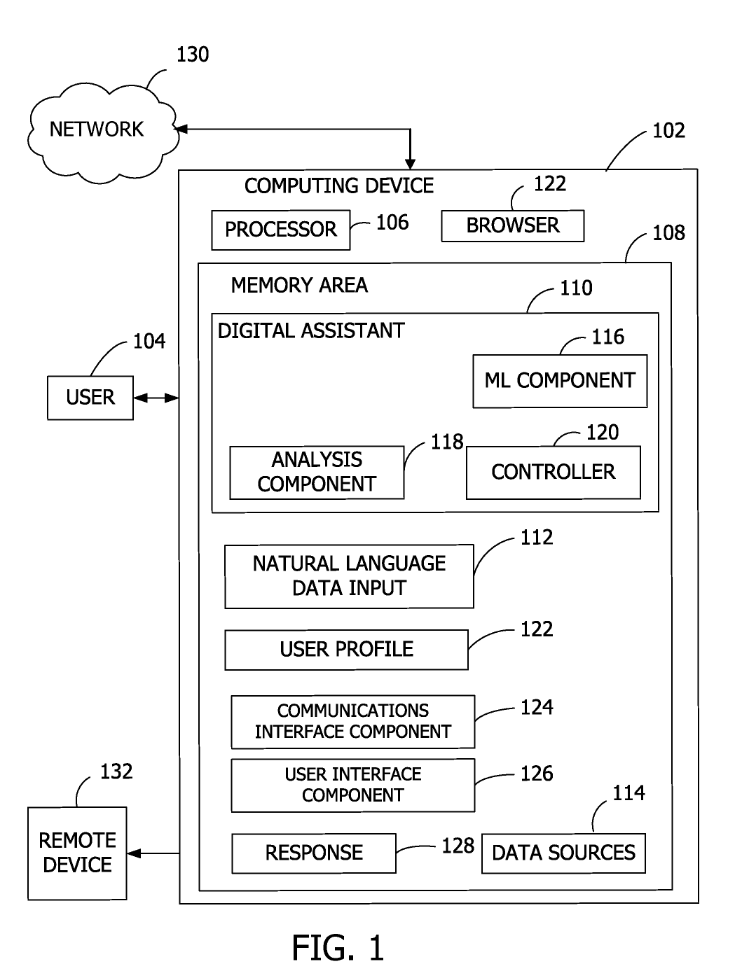

Referring again to FIG. 1, an exemplary block diagram illustrates a computing device for identifying and completing tasks based on natural language input. In the example of FIG. 1, the computing device associated with a user represents a system for receiving unstructured data input, or natural language data input, and identifying intent and domain associated sentiment with the unstructured data input. As used herein, unstructured data is used interchangeably with natural language data. In some examples, natural language data may be textual or spoken user input, for example. In other examples, unstructured data, or natural language data, may be obtained using gesture recognition and visual data, such as detecting sign language via a video interface. Unstructured data may contain text, numbers, dates, symbols, alphanumeric characters, non-alphanumeric characters, sounds, or any combination of the foregoing.

The computing device represents any device executing instructions (e.g., as application programs, operating system functionality, or both) to implement the operations and functionality associated with the computing device. The computing device may include a mobile computing device or any other portable device. In some examples, the mobile computing device includes a mobile telephone, laptop, tablet, computing pad, netbook, gaming device, wearable device, and/or portable media player. The computing device may also include less portable devices such as desktop personal computers, kiosks, tabletop devices, industrial control devices, wireless charging stations, and electric automobile charging stations. Additionally, the computing device may represent a group of processing units or other computing devices.

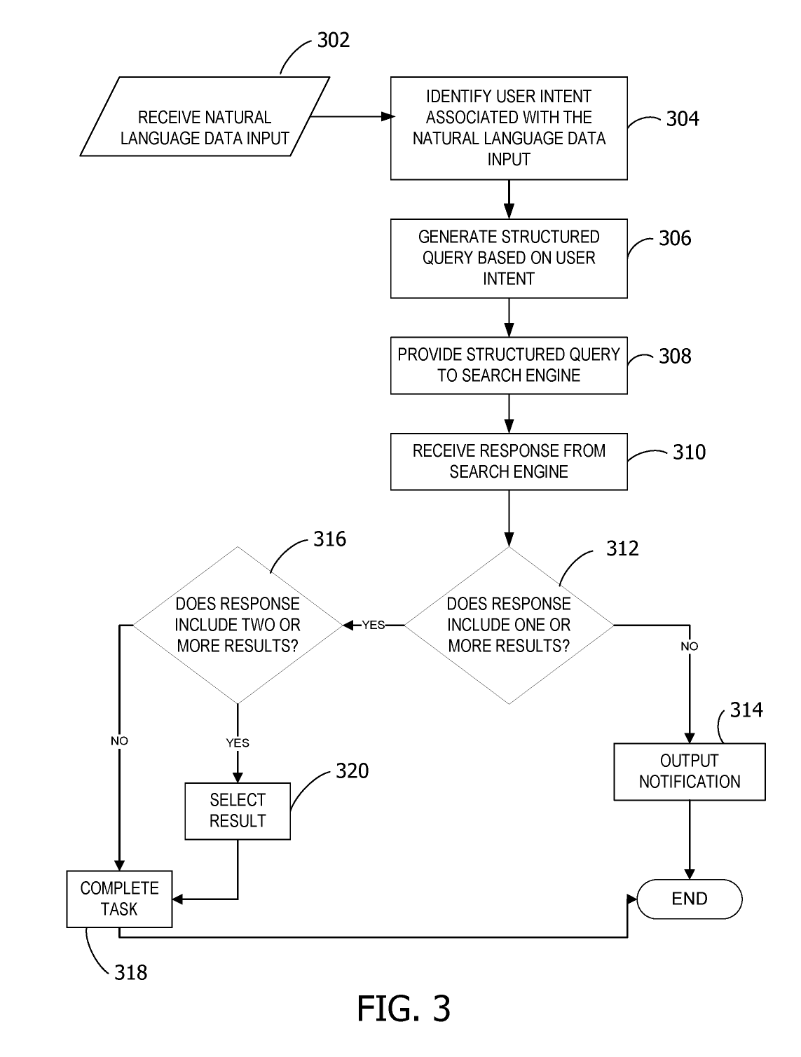

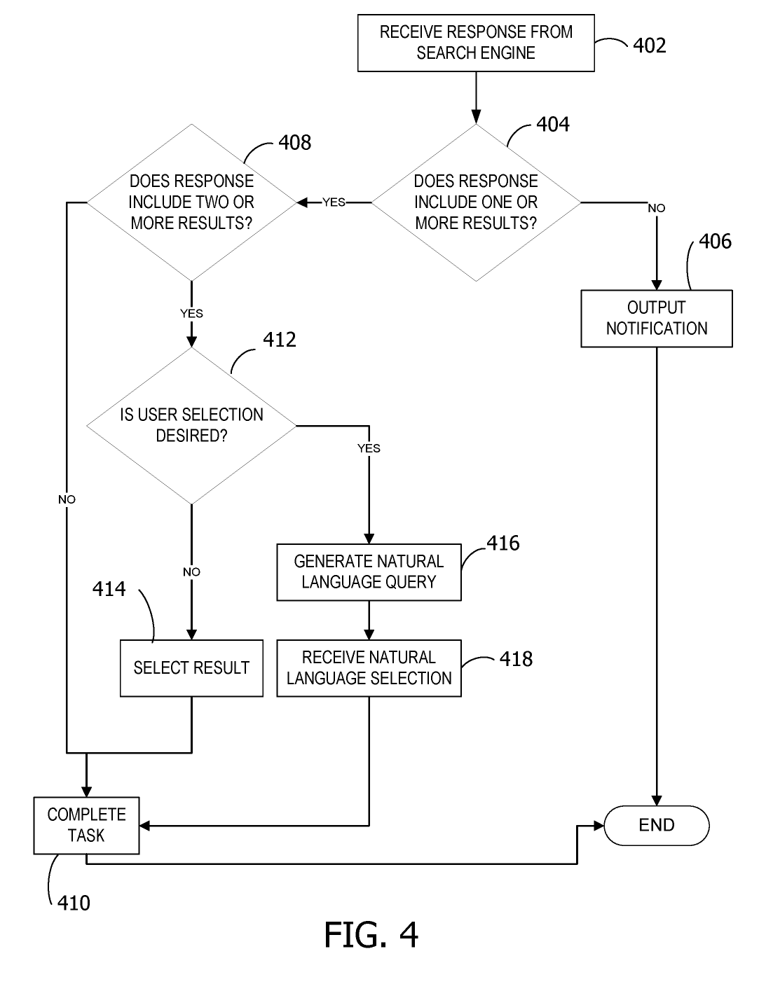

In some examples, the computing device has at least one processor, a memory area, and at least one user interface. The processor includes any quantity of processing units, and is programmed to execute computer-executable instructions for implementing aspects of the disclosure. The instructions may be performed by the processor or by multiple processors within the computing device, or performed by a processor external to the computing device. In some examples, the processor is programmed to execute instructions such as those illustrated in the figures (e.g., FIG. 3-4).

In some examples, the processor represents an implementation of analog techniques to perform the operations described herein. For example, the operations may be performed by an analog computing device and/or a digital computing device.

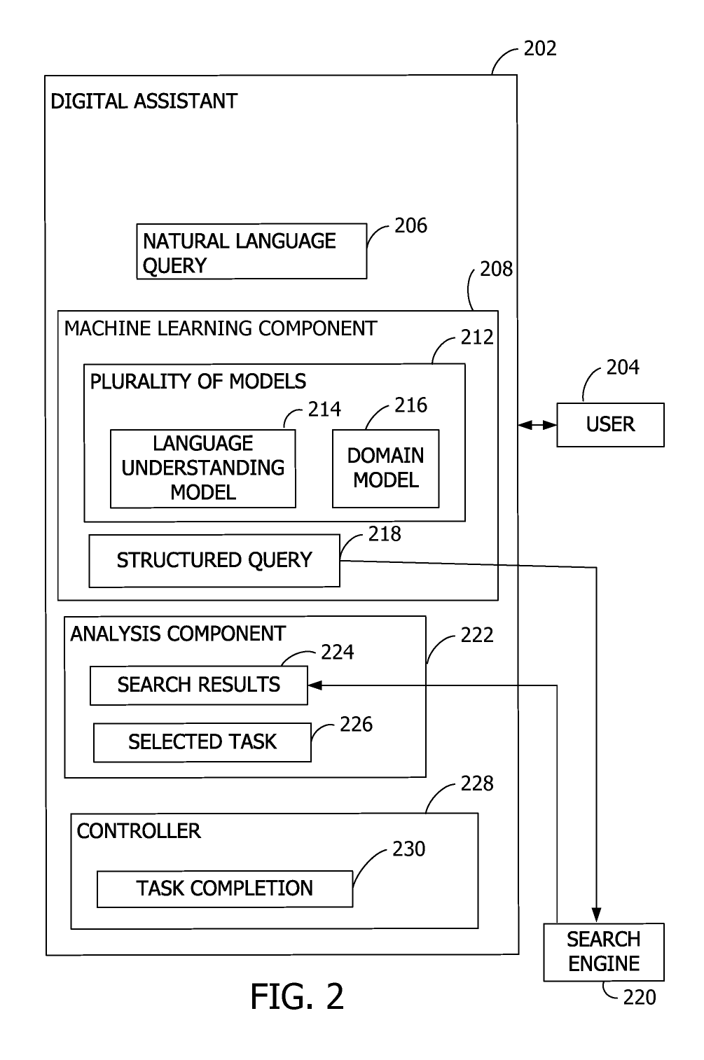

The computing device further has one or more computer readable media such as the memory area. The memory area includes any quantity of media associated with or accessible by the computing device. The memory area may be internal to the computing device (as shown in FIG. 1-2), external to the computing device (not shown), or both (not shown). In some examples, the memory area includes read-only memory or memory wired into an analog computing device, or both.

The memory area stores, among other data, one or more applications. The applications, when executed by the processor, operate to perform functionality on the computing device. Exemplary applications may include mail application programs, web browsers, calendar application programs, address book application programs, messaging programs, media applications, location-based services, search programs, and the like. The applications may communicate with counterpart applications or services such as web services accessible via a network. For example, the applications may represent downloaded client-side applications that correspond to server-side services executing in a cloud. The memory area further stores user profile information associated with a user and/or computing device activity associated with a user.

The memory area further stores one or more computer-executable components. Exemplary components include a communications interface component, a user interface component, and a digital assistant. The user interface component, when executed by the processor of the computing device, causes the processor to output data to the user interface component and process user input received via the user interface component.

In some examples, the communications interface component includes a network interface card and/or computer-executable instructions (e.g., a driver) for operating the network interface card. Communication between the computing device and other devices may occur using any protocol or mechanism over any wired or wireless connection. In some examples, the communications interface is operable with short range communication technologies such as by using near-field communication (NFC) tags.

In some examples, the user interface component includes a graphics card for displaying data to the user and receiving data from the user. The user interface component may also include computer-executable instructions (e.g., a driver) for operating the graphics card. Further, the user interface component may include a display (e.g., a touch screen display or natural user interface) and/or computer-executable instructions (e.g., a driver) for operating the display. The user interface component may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way.

Referring again to FIG. 1, an exemplary block diagram illustrates a computing device for task identification and completion based on natural language. Computing device 102 may be associated with user 104. Computing device 102 may include processor 106 communicatively coupled to memory area 108. Memory area 108 includes digital assistant 110, which may be one implementation of an intelligent agent executed by processor 106 to receive natural language data input 112 from user 104 and use natural language data input 112 to identify and complete an associated task.

Natural language data input 112 may be received from user 104 via spoken language, in some examples. Natural language data input 112 may be an ambiguous query or request. For example, an ambiguous query may be “Play that Paul Walker tribute song” or “Play the song with lyrics I walk a lonely road.” Machine learning component 116 processes natural language data input 112 using a natural language understanding model to identify intent and an appropriate domain for the query, using one or more domain models to generate a structured, or unambiguous, query that may be used by a search engine. For example, machine learning component 116 may identify for input “Play that Paul Walker tribute song” that the intent is to play media and the domain is music. In this illustrative example, processing the input based on the identified intent “play media” and the identified domain “music” may generate a structured query for a search engine using terms such as “Paul Walker”, “tribute”, “song” that returns results such as “See You Again by Wiz Khalifa,” which digital assistant 110 uses to identify an audio track having the title “See You Again” with a corresponding artist “Wiz Khalifa” in a data source or data provider available to computing device 102 and/or user 104.

Digital assistant 110 may use data sources 114 to identify available and/or preferred content to use in completing a selected task from analysis component 118. Data sources 114 may be a plurality of local or remote, or both local and remote, data sources. Data sources 114 may include data access points to data service providers, such as streaming data providers for example, or data access points to data stored remote from computing device 102, in some examples. Machine learning component 116 may generate a structured query based on natural language data input 112 and provide the structured query to browser 122, which returns results to the structured query. Analysis component 118 may receive the results corresponding to the structured query, parse the results, and determine a result for response 128. Analysis component 118 may access user profile 122 to determine user account information, user preference information, user history, and so forth. Analysis component 118 may access data sources 114 to determine services, files, and/or data that user 104 has access to or that is available to user 104, based on user account information from user profile 122, in order to select a source or service to use in completing the task associated with response 128. Response 128 may be information about the determined result and selected data source from analysis component 118 and instructions from controller 120 to output the determined result using the selected data source. For example, analysis component 118 may determine that the result for the response is a specific song, and that the specific song is available to stream from the user's internet radio account. In this example, controller 120 may generate instructions for response 128 that are executed by processor 106, such as playing the specific song from the selected streaming account.

In some examples, digital assistant 110 may also update user profile 122 using response 128, or user feedback received based on response 128. For example, digital assistant 110 may update user profile 122 to indicate that the user requested a specific song, and store it as a recent request.

Communications interface component 124 and user interface component 126 may also be incorporated into memory area 108. In some examples, processor 106 may execute digital assistant 110 to process natural language data input 112 maintained in memory area 108. Digital assistant 110 may generate response 128 corresponding to natural language data input 112 and output response 128 via user interface component 126. In some other examples, one of more components may be implemented remote from computing device 102 and accessible over network 130 via communications interface component 124.

Network 130 may enable computing device 102 to connect with and/or communicate with one or more services or other resources. Additionally, although the components of computing device 102 are depicted as implemented within computing device 102, one or more of these components may be implemented remote from computing device 102 and accessible via network 130. Alternatively, response 128 may be output via communications interface component 124 to remote device 132, where computing device 102 is communicatively coupled to remote device 132 or otherwise configured to output data to a remote device, such as a remote speaker or display, for example. A user may interact with a digital assistant on a mobile computing device using natural language to request a task, with an ambiguous query, and the digital assistant may identify and complete the task using the mobile computing device and/or other devices associated with the mobile computing device. For example, a user may have the user interface of a mobile device mirrored on a remote display, with audio endpoints routed to a remote speaker from the mobile device, such that task completion by the digital assistant includes playing a requested song and sending the audio output to the remote speaker.

FIG. 2 is an exemplary block diagram illustrating a digital assistant identifying and completing a task using natural language input. Digital assistant 202 may be an illustrative example of one implementation of digital assistant 110 in FIG. 1.

Digital assistant 202 may be associated with user 204. User 204 may interact with digital assistant 202 using natural language, such as through spoken word or text for example. Digital assistant 202 may receive natural language query 206, and process natural language query 206 to complete a task.

In this example, digital assistant 202 may use machine learning component 208 to identify an intent associated with natural language query 206, a domain for natural language query 206, and a task corresponding to natural language query 206. Machine learning component 208 includes plurality of models 212 used to process data input and generate unambiguous queries from ambiguous input. Plurality of models 212 may include language understanding model 214 and domain model 216. While a single domain model is provided for illustrated purposes, it is understood that plurality of models 212 may include a number of different domain models, as well as any other suitable model for machine learning component 208 to use in processing natural language and refining plurality of models 212 as user feedback and telemetry data is received.

Language understanding model 214 processes natural language query 206 to determine and/or identify intent associated with natural language query 206. Intent may correspond with a task action, in some examples, such as intent to play media, retrieve information, or perform some other action. Language understanding model 214 may also identify a domain associated with natural language query 206, such that machine learning component 208 determines which domain model of plurality of models 212 to use in processing natural language query 206 to generate structured query 218. In an illustrative example, domain model 216 may be a music domain model, which processes natural language query 206 based on the identified intent of “play song” in order to generate structured query 218 that instructs search engine 220 to crawl for or match the search terms to a song. Search engine 220 may be configured to crawl for content, match query terms with content, rank results by relevance or otherwise categorize results, return an indication when no match is found, and return any results found.

Search engine 220 may return search results 224 to analysis component 222. Search results 224 may be ranked, or otherwise categorized, based on relevance to the structured query. Analysis component 222 processes search results 224, taking into account any rankings provided by search engine 220, to determine a result to use as selected task 226. Analysis component 222 may also factor in user context and user profile information, such as user preferences, user history, user account information, when determining an optimal result for selected task 226.

Selected task 226 may be an identification of data or information corresponding to the result as well as identification of a selected data source or provider for the data in order to complete the task associated with natural language query 206. Controller 228 may generate instructions for selected task 226, which may be used by a processor of the computing device associated with digital assistant 202 to perform task completion 230.

FIG. 3 is an exemplary flow chart illustrating operation of the computing device to identify and complete a task using natural language input. These operations may be performed by a digital assistant executed by a processing unit of a computing device, such as digital assistant 110 executed by processor 106 of computing device 102, for example.

The process begins by receiving natural language data input at operation 302. The natural language data input may be received in real-time, such as from a user interacting with the personal digital assistant implemented on a user device via spoken word, in one example.

The process identifies user intent associated with the natural language data input at operation 304. The user intent may be identified using a machine learning component, and in particular may use a natural language model to process the ambiguous query of the natural language data input and determine intent. The process generates a structured query based on the identified user intent at operation 306. The machine learning component may identify a domain associated with the natural language data input, and process the input using the identified domain model to structure a query based on the user intent.

The process provides the structured query to a search engine at operation 308 and receives a response form the search engine at operation 310. The response may be search results based on the structured query. In some examples, the response may return no results, while in other examples the response may return a single result, or multiple results. The response may include results in a ranked or categorized format indicating relevance to the structured query, in some examples.

The process determines whether the response includes one or more results at operation 312. If the process determines that the response does not include one or more results, the process outputs a notification at operation 314, with the process terminating thereafter. The notification may be output via a user interface component and may indicate that no results were found for the natural language data input. For example, no song was found matching the information in the natural language query received, even after disambiguating the query.

If the process determines that the response does include one or more results, the process determines if the response includes two or more results at operation 316. If the process determines that the response does not contain two or more results, the process completes the task at operation 318 with the single results from the response. For example, if only one song is returned in response to the structured query, the digital assistant plays that song, which completes the task.

If the process determines that the response does include two or more results, the process selects a result at operation 320, and then proceeds to operation 318, with the process terminating thereafter. For example, if three songs are returned the digital assistant may parse the results to determine which song is contextually relevant to the user or which song is the optimal selection for task completion. This may be based on user preference, song availability through data sources the user has access to, or any other suitable factor.

FIG. 4 is an exemplary flow chart illustrating operation of the computing device to confirm an identified and selected task with a user for task completion. These operations may be performed by a digital assistant executed by a processing unit of a mobile device, such as digital assistant 202 in FIG. 2, For example. The process may begin similar to the operations in FIG. 3.

The process receives a response from a search engine at operation 402. The process determines whether the response includes one or more results at operation 404. In response to a determination that the process does not include one or more results, the process outputs a notification at operation 406, with the process terminating thereafter. The notification may be an indication to a user that no results match for the input query, for example.

If the process determines that the response does include one or more results, the process determines if the response includes two or more results at operation 408. In response to a determination that the response does not include two or more results, the process completes the task at operation 410 with the single result. If the process determines there are two or more results, the process determines whether user selection is desired at operation 412. The determination about whether to confirm selection with a user may be a configurable setting, in some illustrative example, where the user prefers to select from multiple results. In other examples, the determination about whether to confirm selection with a user may be driven by the digital assistant determining that, based on context or available information, more than one result may fulfill the desired task. For example, two different versions of the same song by the same artist may be available to play, one having explicit content and one being edited for radio play. In one example, digital assistant may determine that the user preference is for non-explicit content based on a user profile, and select the appropriate result from the multiple results to complete the task.

If the process determines that user selection is not desired at operation 412, the process selects a result at operation 414 and proceeds to operation 410. If the process determines that user selection is desired, the process generates a natural language query at operation 416 that is output via a user interface component. For example, the digital assistant may ask a user which song in a list of songs, or between two songs, that the user would like to have played, or may convey information about the two or more results that match the structured query. The process receives natural language selection at operation 418, such as by additional natural language input from the user, and process to operation 410. For example, the user may indicate which result is desired for the task. This may also be used by machine learning component to refine one or more models and increase accuracy of structured queries in future user interaction with the digital assistant.

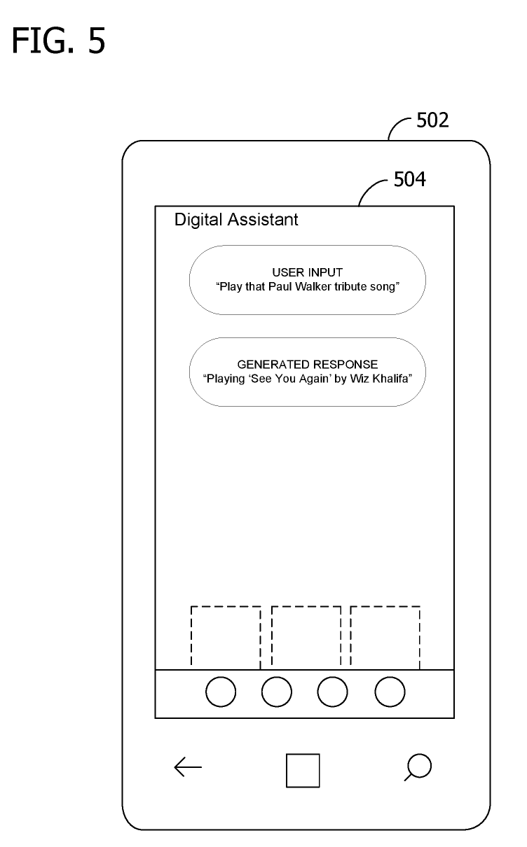

Referring to FIG. 5, an exemplary block diagram illustrating a mobile device implementing the digital assistant is depicted. Mobile device 502 may be any mobile computing device, including, without limitation, a mobile phone, personal digital assistant (PDA), tablet, laptop, wearable computing device, or any other suitable mobile device. In one example, mobile device 502 is an illustrative example of computing device 202 in FIG. 2.

Mobile device 502 provides an exemplary operation of digital assistant 504 receiving unstructured data, such as user input in natural language, and providing a response or output to the natural language user input that completes a task associated with the user input, by identifying intent and generating a structured query to identify and select a result that satisfies the user input. In this depicted example, the digital assistant receives an ambiguous query in the form of user input, possibly through a natural language conversation between the digital assistant and the user. The digital assistant analyzes the user input and identifies “play song” as the intent of the user input, and music as the domain.

The digital assistant uses identified intent and domain to structure a query and receive results that are contextually relevant to the ambiguous user input. The digital assistant analysis the results to identify a result for task completion, or alternatively to identify a sub-set of results to present to the user for confirmation and/or selection and task completion. Although a textual response is depicted for illustrative purposes, digital assistant 504 may respond with the task completion, such as by beginning play of the identified song with no other output, in some examples.

As another example, if the user says, “Play the song with lyrics I walk a lonely road”, the digital assistant may identify the intent as “play song” and may further receive results to a structured query that includes the song title “Boulevard of Broken Dreams” and artist “Green Day.” In another example, user input may be “Play the song with Queen and David Bowie”, which may return a result for “Under Pressure” as a song title. In yet another example, user input may be “Play the song from Frozen with Prince Hans and Anna”, which may return a ranked list of results, which the top result being “Love is an Open Door” performed by Kristen Bell, and a second result being “Let it Go” as performed by Idina Menzel, and a third result being “Let it Go” as performed by Demi Lovato. In this illustrative example, the ranked results may indicate a relational relevance to the structured query generated and provided based on the ambiguous user input, which may then be evaluated by the analysis component of the digital assistant to identify the result that best completes the task associated with the user input.

Often, a user may not remember the title of the song, but may recall contextual elements associated with the song, such as a portion of the lyrics, an artist who performed the song, a movie associated with the song, and so forth. Rather than performing a search for relevant context when looking for a song such as “Paul Walker Tribute Song” then looking at search results and finding a matching song name, providing the matching song name to the user, then receiving a natural language request to play the exact song name found in the search results, the present disclosure combines these processes into a streamlined approach that identifies the desired content or information from the contextual natural language query and machine learning inferences in order to complete the task.

By using natural language to find contextually relevant results instead of requiring specific and complete queries in a particular format, a user may interact with a digital assistant using the contextual information readily available to the user to find content—such as a song—without having to specify a full track title, artist name, or album information. Additionally, the digital assistant has the ability to infer contextually appropriate content information from an ambiguous query using machine learning and leverage any relevance rankings provided by a search engine. Where desired, the digital assistant interacts with a user in a natural language interface environment to clarify through conversation which result best satisfies the user intent, such as asking the user to clarify which song to play if multiple songs are available that match the query.

In other examples, if the system finds no content of relevance to the ambiguous query, the digital assistant is able to inform the user that relevant content is not found, in order to prompt a user to provide additional contextual information. For example, if the system finds no song, artist, or album matching any of features of the ambiguous natural language query, but identifies an intent to play music, the digital assistant may provide a notification or output that indicates a relevant song cannot be found, or request additional information to add to the contextual information in order to refine the structured query.

In some examples, the system may identify exactly one result and automatically complete the task with that single result. For example, if the system finds exactly one song, the system begins playing the song without any further interaction, notification, or confirmation from the user.

### ADDITIONAL EXAMPLES

In some example scenarios, the digital assistant is able to run across multiple devices and device types, as well as multiple operating systems. Aspects of this disclosure enable the digital assistant to deliver consistent user experiences across devices and platforms, such as the ability to play music on any device with the same contextually relevant interaction and user experience.

In some other examples, aspects of the present disclosure enable a digital assistant to identify tasks and complete tasks with contextual queries instead of exact queries. For example, often times, the user can think of a song and the context around it, or partial lyrics within it, but cannot remember the name of the song. Providing the user with the ability to interact with the digital assistant using natural language, with relevant context, and providing a digital assistant able to identify the information the user is seeking based on that natural language input, inference, and contextual signals, provides a user experience of increased performance and efficiency.

Alternatively, or in addition to the other examples described herein, examples include any combination of the following:
a machine learning component that processes the received natural language data input to identify the user intent and a domain for the structured query;
wherein the machine learning component uses one or more domain models to generate the structured query for the natural language data input based on the identified user intent;
wherein the digital assistant uses one or more data sources to identify content associated with the selected result for task completion;
wherein the digital assistant obtains user profile information and selects the result for task completion based at least in part on the user profile information;
select a data source to use in association with the selected result for task completion;
generate instructions corresponding to an action and the selected result for task completion;
perform the action using the generated instructions and the selected data source;
update a user profile based at least in part on the performed action;
a machine learning component that identifies the user intent and the domain associated with the natural language input;
an analysis component that processes the one or more results received from the search engine using the user context and user profile information to select the result for the identified domain;
a controller that generates instructions corresponding to the task associated with the selected result;
responsive to a determination that the response does not include one or more results, outputting a notification indicating no results were found for the natural language data input;
wherein the natural language data input is received and processed in real-time;
processing the ambiguous query using a natural language model to identify the user intent;
identifying a domain associated with the natural language input;
processing the natural language input using a domain model associated with the identified domain to generate the structured query based on the identified user intent;
wherein the identified user intent is to play media and the identified domain is music;
determining whether the response includes two or more results;
responsive to a determination that the response does not include two or more results, completing a task with a single result of the response;
responsive to a determination that the response does include two or more results, determining whether user selection is desired;
responsive to a determination that the user selection is not desired, selecting the result for task completion based at least in part on user context;
responsive to a determination that the user selection is desired, generating a natural language query corresponding to the two or more results to output via a user interface component;
wherein the received natural language data input includes contextual elements used by a machine learning component to identify the user intent.

At least a portion of the functionality of the various elements in FIG. 2 may be performed by other elements in FIG. 1, or an entity (e.g., processor, web service, server, application program, computing device, etc.) not shown in FIG. 1.

In some examples, the operations illustrated in FIG. 3-4 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

In examples involving a general-purpose computer, aspects of the disclosure transform the general-purpose computer into a special-purpose computing device when configured to execute the instructions described herein.

### Exemplary Operating Environment

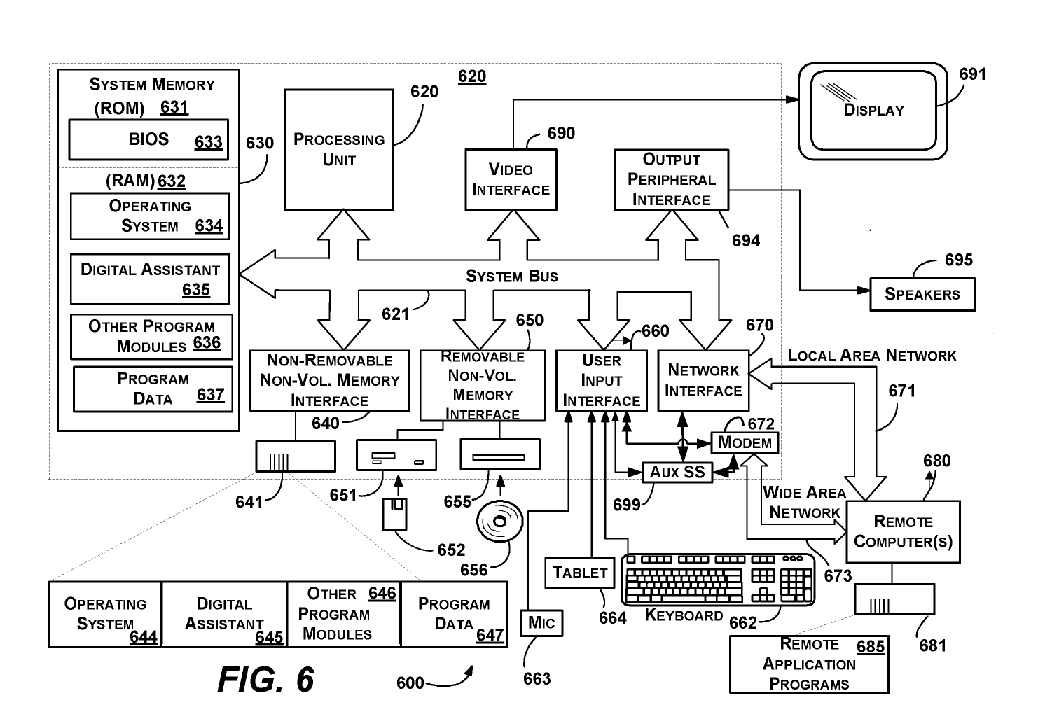

FIG. 6 illustrates an example of a suitable computing and networking environment 600 on which the examples of FIGS. 1-5 may be implemented. The computing system environment 600 is only one example of a suitable computing environment and is not intended to suggest any limitation as to the scope of use or functionality of the disclosure. Neither should the computing environment 600 be interpreted as having any dependency or requirement relating to any one or combination of components illustrated in the exemplary operating environment 600.

The disclosure is operational with numerous other general purpose or special purpose computing system environments or configurations. Examples of well-known computing systems, environments, and/or configurations that may be suitable for use with the disclosure include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the disclosure may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media may be any available media that may be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, or program modules. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may accessed by the computer 610.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, digital assistant 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile memory 652, and an optical disk drive 655 that reads from or writes to a removable, nonvolatile optical disk 656 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, digital assistant 645, other program modules 646 and program data 647. Note that these components may either be the same as or different from operating system 634, digital assistant 635, other program modules 636, and program data 637. Operating system 644, digital assistant 645, other program modules 646, and program data 647 are given different numbers herein to illustrate that, at a minimum, they are different copies. A user may enter commands and information into the computer 610 through input devices such as a tablet, or electronic digitizer, 664, a microphone 663, and a keyboard 662. Other input devices not shown in FIG. 6 may include a touchpad, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A display 691 or other type of display device is also connected to the system bus 621 via an interface, such as a video interface 690. The display 691 may also be integrated with a touch-screen panel or the like. Note that the monitor and/or touch screen panel may be physically coupled to a housing in which the computing device 610 is incorporated, such as in a tablet-type personal computer. In addition, computers such as the computing device 610 may also include other peripheral output devices such as speakers 695, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

The examples illustrated and described herein as well as examples not specifically described herein but within the scope of aspects of the disclosure constitute exemplary means for identifying and completing a task based on natural language input. For example, the elements illustrated in FIG. 1-2, such as when encoded to perform the operations illustrated in FIG. 3-4, constitute exemplary means for identifying user intent and domain from a natural language query, exemplary means for generating a structured query based on the user intent and domain identified, and exemplary means for identifying and selecting a result for task completion based on search results returned for the structured query.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A system for task completion using a digital assistant, said system comprising:
a memory area associated with a computing device, the memory area including a digital assistant; and
a processor communicatively coupled to the memory area that executes the digital assistant to:
receive natural language data input;
identify a user intent associated with the received natural language data input;
generate a structured query for the natural language data input based on the identified user intent;
receive a response to the structured query from a search engine;
determine whether the received response includes one or more results; and
responsive to a determination that the response includes one or more results, select a result from the one or more results for task completion based at least in part on user context.

2. The system of claim 1, wherein the digital assistant further comprises:
a machine learning component that processes the received natural language data input to identify the user intent and a domain for the structured query.

3. The system of claim 2, wherein the machine learning component uses one or more domain models to generate the structured query for the natural language data input based on the identified user intent.

4. The system of claim 1, wherein the digital assistant uses one or more data sources to identify content associated with the selected result for task completion.

5. The system of claim 1, wherein the digital assistant obtains user profile information and selects the result for task completion based at least in part on the user profile information.

6. The system of claim 1, wherein the processor further executes the digital assistant to:
select a data source to use in association with the selected result for task completion;
generate instructions corresponding to an action and the selected result for task completion; and
perform the action using the generated instructions and the selected data source.

7. The system of claim 6, wherein the processor further executes the digital assistant to:
update a user profile based at least in part on the performed action.

8. A mobile computing device comprising:
a memory area storing a digital assistant; and
a processor configured to execute the digital assistant to:
receive natural language input via a user interface component of the mobile computing device;
identify user intent and a domain associated with the natural language input;
generate a structured query for the natural language input based at least in part on the identified user intent and the identified domain;
receive one or more results for the structured query from a search engine;
select a result for the identified domain based at least in part on user context; and
complete a task associated with the natural language input using the selected result.

9. The mobile computing device of claim 8, wherein the digital assistant further comprises:
a machine learning component that identifies the user intent and the domain associated with the natural language input.

10. The mobile computing device of claim 8, wherein the digital assistant further comprises:
an analysis component that processes the one or more results received from the search engine using the user context and user profile information to select the result for the identified domain.

11. The mobile computing device of claim 8, wherein the digital assistant further comprises:
a controller that generates instructions corresponding to the task associated with the selected result.

12. A method for task completion using a digital assistant, the method comprising:
receiving, at a computing device implementing the digital assistant, natural language data input;
identifying a user intent associated with the natural language data input;
generating a structured query for the natural language data input based on the identified user intent;
providing the structured query to a search engine;
receiving a response to the structured query from the search engine;
determining whether the response includes one or more results; and
responsive to a determination that the response includes one or more results, selecting a result for task completion based at least in part on user context.

13. The method of claim 12, further comprising:
responsive to a determination that the response does not include one or more results, outputting a notification indicating no results were found for the natural language data input.

14. The method of claim 12, wherein the natural language data input is received and processed in real-time.

15. The method of claim 12, wherein the natural language data input is an ambiguous query, and further comprising:
processing the ambiguous query using a natural language model to identify the user intent.

16. The method of claim 12, wherein generating the structured query further comprises:
identifying a domain associated with the natural language input; and
processing the natural language input using a domain model associated with the identified domain to generate the structured query based on the identified user intent.

17. The method of claim 16, wherein the identified user intent is to play media and the identified domain is music.

18. The method of claim 12, wherein selecting the result for task completion further comprises:
determining whether the response includes two or more results; and
responsive to a determination that the response does not include two or more results, completing a task with a single result of the response.

19. The method of claim 18, further comprising:
responsive to a determination that the response does include two or more results, determining whether user selection is desired;
responsive to a determination that the user selection is not desired, selecting the result for task completion based at least in part on user context; and
responsive to a determination that the user selection is desired, generating a natural language query corresponding to the two or more results to output via a user interface component.

20. The method of claim 12, wherein the received natural language data input includes contextual elements used by a machine learning component to identify the user intent.
